(19) United States
(12) Patent Application Publication
(10) Pub. No.: US 2008/0043162 A1
(43) Pub. Date: Feb. 21, 2008

(54) LCD sheet and LCD panel

(75) Inventors: Jen-Lang Tung, Kaohsiung City (TW); Ya-Chieh Chen, Hsinchu City (TW)

Correspondence Address: RABIN & Berdo, PC, 1101 14TH STREET, NW, SUITE 500, WASHINGTON, DC, 20005, US

(73) Assignee: AU OPTRONICS CORP.

(21) Appl. No.: 11/647,214

(22) Filed: Dec. 29, 2006

(30) Foreign Application Priority Data
Aug. 16, 2006 (TW) 95130148

(51) Int. Cl. G02F 1/1333

(52) U.S. Cl. 349/40

(57) ABSTRACT

A liquid crystal display (LCD) sheet is provided. The LCD sheet comprises a first substrate, a second substrate and a liquid crystal (LC) layer. The second substrate is parallel to the first substrate, and comprises a panel region, a non-panel region, a first wire, a second wire, a third wire, a fourth wire and a first electrostatic discharge (ESD) protection device. The first and the second wires are disposed on the panel region. The first ESD protection device is disposed on the panel region, and is electrically connected to the first and the second wires. The third and the fourth wires are disposed on the non-panel region, and are electrically connected to the first wire and the second wire, respectively. The LC layer is disposed between the first and the second substrates.

This application claims the benefit of Taiwan patent application Serial No. 95130148, filed Aug. 16, 2006, the subject matter of which is incorporated herein by reference.

### BACKGROUND OF THE INVENTION

1. Field of the Invention

The invention relates in general to a liquid crystal display (LCD) sheet, and more particularly, to an LCD sheet disposing an electro-static discharge (ESD) protection device on the conductive wire.

2. Description of the Related Art

With the advance in technology, liquid crystal display (LCD) panel has been widely applied in various electronic products such as TV, computer screen, notebook computer, mobile phone and personal digital assistant (PDA). The polymer-stabilized alignment (PSA) technology for manufacturing the multi-domain alignment type LCD panel is particularly valued due to the features of short response time, wide view-angle, high aperture ratio, high contrast and simple manufacturing process.

According to the PSA technology for manufacturing a display panel, a small amount of reactive monomers are added to the liquid crystal (LC) layer disposed between the first substrate and the second substrate, such that the liquid crystal molecules are mixed with the reactive monomers. Next, when voltage and ultra-violet (UV) light are applied onto the first substrate and the second substrate, the reactive monomers are separated from the liquid crystal molecules to form polymers on the surface of the first substrate and the second substrate. When the polymers on the LC layer are stacked towards the interface between the first substrate and the second substrate, the polymers are stacked along the direction of the liquid crystal molecules direction due to the interaction between the polymers and the liquid crystal molecules. Thus, the liquid crystal molecules must have a pre-tilt angle in a particular direction.

It is noted that according to conventional polymer-stabilized alignment technology, wires must be extended to an edge of the LCD panel and be used for applying voltage in PSA manufacturing process. However, electro-static charges generated during LCD panel manufacturing process, such as LCD panel edge cutting, rubbing, or moving will enter the LCD panel via the wires extended to the edge of the LCD panel and damage it. Such that, the LCD panel is more likely to be damaged during manufacture process and the yield rate of the LCD panel is decreased.

### SUMMARY OF THE INVENTION

The invention is directed to provide a liquid crystal display (LCD) sheet and an LCD panel. An electro-static discharge (ESD) protection device is disposed on the wire extended to an edge of the LCD panel to effectively prevent the electro-static charge generated at LCD panel edge from entering the LCD panel via the wire, such that the LCD panel is less likely to be damaged by the incoming electro-static charge during the manufacturing process, and the yield rate in the production of LCD panel is greatly increased.

According to the first aspect of the present invention, an LCD sheet is provided. The LCD sheet comprises a first substrate, a second substrate, a first wire, a second wire, a third wire, a fourth wire, a first electrostatic discharge (ESD) and a liquid crystal (LC) layer. The second substrate has a plurality of panel regions and an non-panel region and is disposed parallel to the first substrate. The first wire and the second wire are both disposed on the second substrate and in the panel regions. The first ESD protection device disposed on the second substrate and electrically connected to the first and the second wires. The third wire and the fourth wire are both disposed on the second substrate and in the non-panel region and electrically connected to the first wire and the second wire, respectively. The LC layer is disposed between the first and the second substrates.

According to the second aspect of the invention, an LCD panel is provided. The LCD panel comprises a first substrate, a second substrate, a first wire, a second wire, an ESD protection device and a LC layer. The second substrate has a wire region and a display region and is parallel to the first substrate. The first and the second wires are both disposed on the second substrate and in the wire region. One end of the first wire is substantially extended to an edge of the second substrate. The ESD protection device is disposed on the second substrate and in the wire region, and is electrically connected to the first and the second wires. The LC layer is disposed between the first and the second substrates.

The invention will become apparent from the following detailed description of the preferred but non-limiting embodiments. The following description is made with reference to the accompanying drawings.

### BRIEF DESCRIPTION OF THE DRAWINGS

FIG. 1A is a top view of the structure of an LCD sheet according to a first embodiment of the invention;

FIG. 1B is a cross-sectional view along the cross-sectional line A′ of FIG. 1A;

FIG. 2 is a top view of the structure of an LCD panel divided from the LCD sheet of FIG. 1A;

FIG. 3 is a circuit diagram of an ESD protection device of FIG. 2;

FIG. 4A is a circuit diagram of an ESD protection device according to a second embodiment of the invention;

FIG. 4B is a cross-sectional view of the structure of an ESD protection device of FIG. 4A;

FIG. 5 is a circuit diagram of an ESD protection device according to a third embodiment of the invention;

FIG. 6A is a circuit diagram of an ESD protection device according to a fourth embodiment of the invention;

FIG. 6B is a detailed circuit diagram of a diode array of FIG. 6A;

FIG. 7A is a circuit diagram of an ESD protection device according to a fifth embodiment of the invention;

FIG. 7B is a detailed circuit diagram of a diode array of FIG. 7A;

FIG. 8A is a circuit diagram of an ESD protection device according to a sixth embodiment of the invention;

FIG. 8B is a detailed circuit diagram of a diode array of FIG. 8A.

### DETAILED DESCRIPTION OF THE INVENTION

### First Embodiment

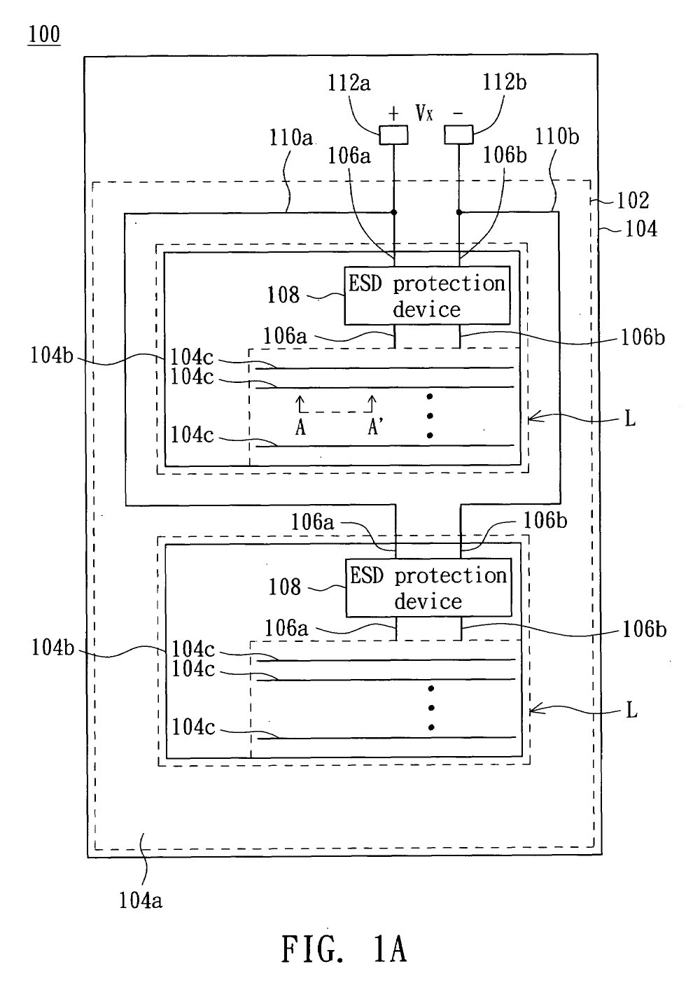

Referring to FIGS. 1A and 1B, FIG. 1A is a top view of the structure of an LCD sheet according to a first embodiment of the invention, and FIG. 1B is a cross-sectional view along the cross-sectional line AA′ of FIG. 1A. The LCD sheet 100 comprises a first substrate 102, a second substrate 104, wires 106a, 106b, 110a and 110b, an electrostatic discharge (ESD) protection device 108 and a liquid crystal (LC) layer 103. The second substrate 104 has a couple of panel regions 104b and a non-panel region 104a and is disposed parallel to the first substrate 102. The wires 106a and 106b and the ESD protection device 108 are disposed on the second substrate 104 and in the panel region 104b. The wires 106a and 106b are electrically connected to the ESD protection device 108. The wires 110a and 110b are disposed on the second substrate 104 and in the non-panel region 104a, and are electrically connected to the wires 106a and 106b, respectively. The wires 110a and 110b are further electrically connected to two input ends 112a and 112b, respectively.

The first substrate 102 and the second substrate 104 respectively comprise a common electrode 102a and a plurality of electrode lines 104c. The electrode lines 104c are positioned on the second substrate 104. In the present embodiment of the invention, the wires 106a and 106b are used as PSA manufacturing process wires, and are electrically connected to the common electrode 102a and the electrode lines 104c, respectively. The wires 106a are electrically connected to the common electrode 102a, for example, through Au or Ag balls (not illustrated). The LC layer 103 comprises a polymer layer 103a and a plurality of liquid crystal molecules 103b. Before the PSA manufacturing process is applied to the LCD sheet 100 of the present embodiment of the invention, the LC layer 103 comprises a plurality of monomers (not illustrated) and liquid crystal molecules 103b. The monomers are mixed with the liquid crystal molecules 103b. Next, a cross-voltage Vx is provided via the input ends 112a and 112b to apply a voltage to the common electrode 102a and the electrode line 104c to drive the liquid crystal molecules 103b of the LC layer 103. After the exposure by ultra-violet light, the monomers are polymerized to form a polymer layer 103a on the surface of the first substrate 102 and the second substrate 104. The polymer layer 103a contacts the LC layer 103 and provides a pre-tilt angle to the liquid crystal molecules 103b.

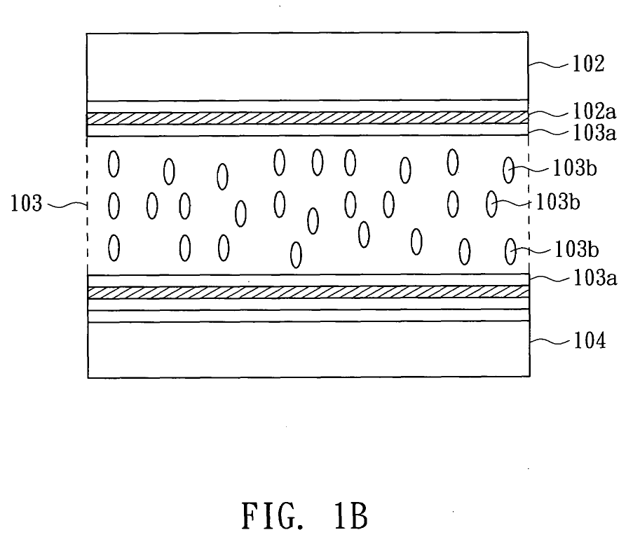

After the LCD sheet 100 is divided along the cutting line L, several LCD panels 200 are obtained. Referring to FIG. 2, a top view of the structure of an LCD panel divided from the LCD sheet of FIG. 1A is shown. The LCD panel 200 comprises a colored filter (CF) substrate 202, a thin film transistor (TFT) substrate 204 and an LC layer (not illustrated). The TFT substrate 204 has a wire region 204a and a display region 204b and is parallel or opposite to the CF substrate 202. The wire region 204a is disposed around an edge of the TFT substrate 204 (that is, the wire region 204a is disposed around the display region 204b). The wires 106a and 106b and the ESD protection device 108 are disposed on the TFT substrate 204 and in the wire region 204a. One end of the wires 106a and one end of the wires 106b are substantially extended to an edge of the TFT substrate 204. Besides, one end of the wires 106a and one end of the wires 106b can be extended to a first side and a second side of the TFT substrate 204, respectively. The first side and the second side are opposite or adjacent. In other words, one end of the wires 106a and one end of the wires 106b are substantially extended to a boundary of the TFT substrate 204.

The ESD protection device 108 is electrically connected to the wires 106a and 106b to prevent external electro-static charges from entering the LCD panel 200 via the wires 106a and 106b extended to the edge of the substrate 204, lest the internal circuit of the LCD panel 200 might be damaged by incoming electro-static charges.

The LCD panel 200 comprises a plurality of electrode lines 104c disposed on the second substrate 204 in parallel and electrically connected to the wire 106b. The LCD panel 200 further comprises a plurality of scan lines 204d and data lines 204e, and ESD protection devices 210a and 210b. The scan lines 204d are disposed on the second substrate 204 in parallel and are also disposed between two neighboring electrode lines 104c in parallel. The scan lines 204d are electrically connected to the ESD protection device 210b. The data lines 204e are also disposed on the second substrate 204 in parallel and criss-cross with the electrode line 104c and the scan lines 204d. The data lines 204e are electrically connected to the ESD protection device 210a. A pixel is defined by two neighboring scan lines 204d and two neighboring data lines 204e. Each pixel comprises a TFT, a pixel electrode and a storage capacitor. The three ends of the TFT are corresponding to and electrically connected to a data line on a pixel edge, a scan line on a pixel edge, and the pixel electrode, respectively. The ESD protection devices 210a and 210b are respectively used to prevent the data line 204e and the scan lines 204d from being damaged by incoming electro-static charges.

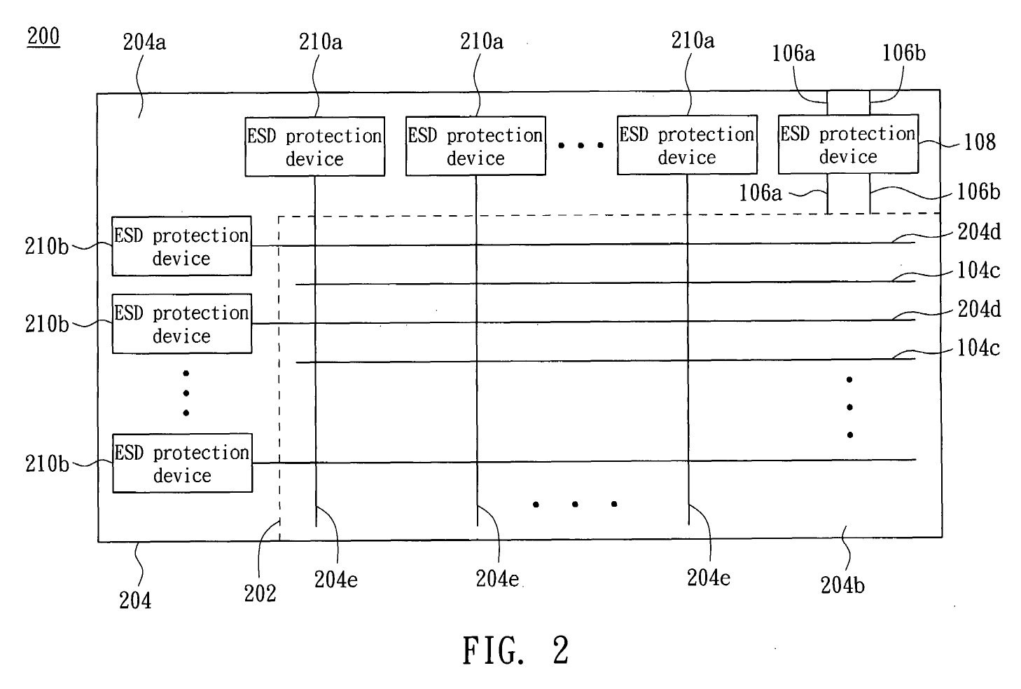

Referring to FIG. 3, a circuit diagram of an ESD protection device of FIG. 2 is shown. The ESD protection device 108 comprises two capacitances 302a and 302b electrically connected to wires 106a and 106b, respectively. When the electro-static charges are discharged and generate an electro-static current, the capacitances 302a and 302b effectively prevent the electro-static current from flowing into the internal circuit of LCD panel 200, hence achieving electro-static discharge protection.

Thus, the LCD sheet of the present embodiment of the invention and the LCD panel effectively resolves the high cost problem of conventional PSA process which is applicable to only one LCD panel at a time. Moreover, the electro-static charges generated at the LCD panel edge are effectively prevented from entering the LCD panel via the wire, such that the LCD panel is less likely to be damaged by the incoming electro-static charges during the manufacturing process, and the yield rate in the production of LCD panel is greatly increased.

### Second Embodiment

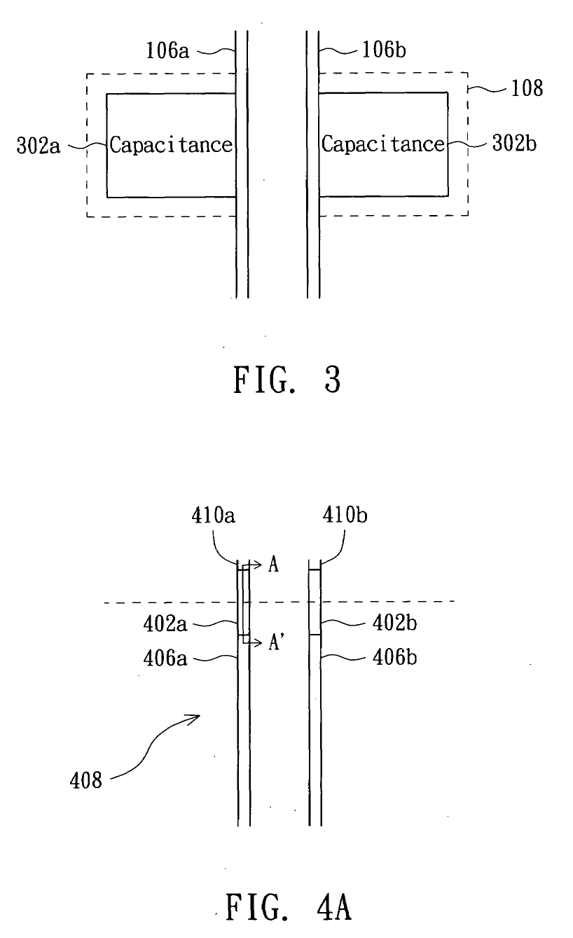

Referring to FIG. 4A and FIG. 4B. FIG. 4A is a circuit diagram of an ESD protection device according to a second embodiment of the invention. FIG. 4B is a cross-sectional view of the structure of an ESD protection device of FIG. 4A. The present embodiment of the invention differs with the first embodiment in that the wires 406a, 406b, 410a and 410b of the present embodiment of the invention are double metal layered, and the border between the wires 406a and 410a as well as the border between the wires 406b and 410b are respectively connected by the wires 402a and 402b which are single metal layered. There is an insulating layer 404a disposed between the double metal layers of the wires 406a and 410a. The insulating layer 404a has a contact hole 404b via which the double metal layers of the wires 406a and 410a are electrically connected. The present embodiment of the invention is further exemplified by the situation that the electro-static current generated by the electro-static discharge external to the LCD panel 200 flows through the wires 406a, 402a and 410a.

When the electro-static charges are discharged and generate a positive electro-static current, the positive electro-static current enters the LCD panel 200 by passing through the wires 410a and 402a sequentially. Meanwhile, the structure of the single metal layer of the wire 402a will break due to the high density of the current flowing through the cross-section. When the electro-static charges are discharged and generate a reverse electro-static current, the reverse electro-static current is dissipated from the LCD panel 200 by passing through the wires 406a and 402a sequentially. Meanwhile, the structure of the single metal layer of the wire 402a will break due to the high density of the current flowing through the cross-section. The broken wire 402a avoids the generation of electro-static current, hence achieving electro-static discharge protection.

The present embodiment of the invention is exemplified by the situation that the electro-static current flows through the wires 410a, 402a and 406a. However, the situation that the electro-static current flows through the wires 410b, 402b and 406b can be obtained by the same way.

### Third Embodiment

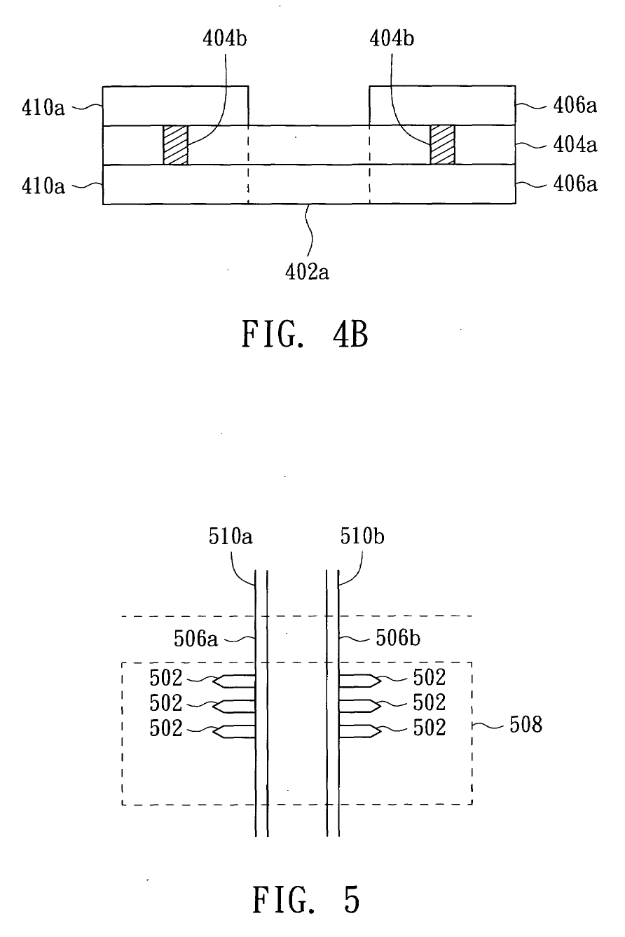

Referring to FIG. 5, a circuit diagram of an ESD protection device according to a third embodiment of the invention is shown. The present embodiment of the invention differs with the first embodiment in that in the present embodiment of the invention, a plurality of lightening protectors 502 are electrically connected to the wires 506a and 506b, respectively, and an ESD protection device 508 is formed by the circuit structure of the lightening protectors 502 and the wires 506a and 506b. Thus, when the electro-static charges are discharged and generate an electro-static current, the lightening protector 502 discharges the electro-static current according to the mechanism of point discharge, such that the electro-static current is prevented from entering the LCD panel and the electro-static discharge protection is achieved.

### Fourth Embodiment

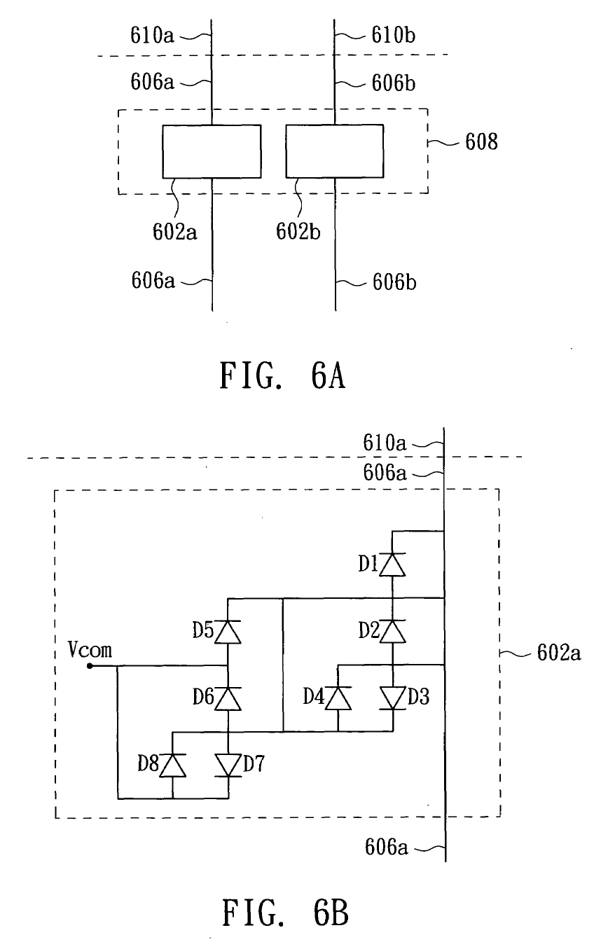

Referring to FIGS. 6A and 6B, FIG. 6A is a circuit diagram of an ESD protection device according to a fourth embodiment of the invention. FIG. 6B is a detailed circuit diagram of a diode array of FIG. 6A. The present embodiment of the invention differs with the first embodiment in that in the present embodiment of the invention, the diode arrays 602a and 602b are serially connected with the wires 606a and 606b respectively, and an ESD protection device 608 is formed by the circuit structure of the diode arrays 602a and 602b. The present embodiment of the invention is further exemplified below using the example of the diodes D1˜D8 of the diode array 602a.

When the electro-static charges are discharged and generate a positive electro-static current, the positive electro-static current sequentially flows through the wires 610a, 606a, and the diodes D2 and D6 to be inputted to a common electrode Vcom. When the external electro-static charges are discharged and generate a reverse electro-static current, the positive electro-static current starts from the common electrode Vcom, and sequentially flows through the diodes D5 and D1, and the wires 606a and 610a to be outputted. When the electro-static charges are discharged, the diode array 602a of the present embodiment of the invention effectively discharges the positive electro-static current and the reverse current via another path, such that the electro-static current is prevented from entering the internal circuit of the LCD panel 200, and the electro-static discharge protection is achieved. The present embodiment of the invention is exemplified using the example of the diode array 602a and the diode D1˜D8 thereof. However, the structure of the diode array 602b and the electro-static discharge protection achieved thereby can be obtained in the same way as the diode array 602a does.

### Fifth Embodiment

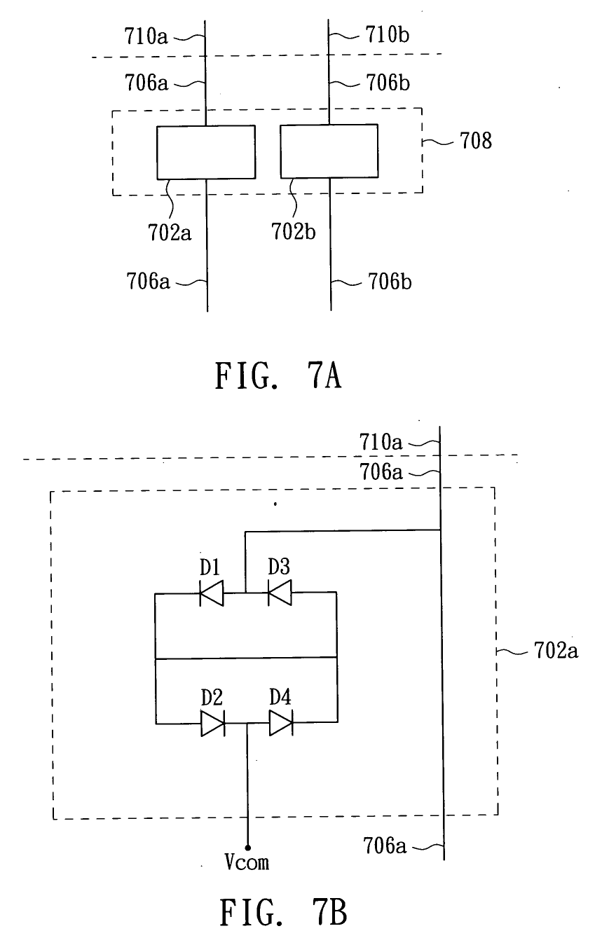

Referring to FIGS. 7A and 7B. FIG. 7A is a circuit diagram of an ESD protection device according to a fifth embodiment of the invention. FIG. 7B is a detailed circuit diagram of a diode array of FIG. 7A. The present embodiment of the invention differs with the fourth embodiment in that the diode arrays 702a and 702b of the present embodiment of the invention have different structures of electrical connection for the diodes. The present embodiment of the invention is further exemplified below using the example of the diodes D1˜D4 of the diode array 702a.

When the electro-static charges are discharged and generate a positive electro-static current, the positive electro-static current sequentially flows through the wires 710a, 706a, the diodes D1 and D2 to be inputted to a common electrode Vcom. When the external electro-static charges are discharged and generate a reverse electro-static current, the positive electro-static current starts from the common electrode Vcom and sequentially flows through the diodes D4, D3, the wires 706a and 710a to be outputted. When the electro-static charges are discharged, the diode array 702a of the present embodiment of the invention effectively discharges the positive electro-static current and the reverse current via another path, such that the electro-static current is prevented from entering the internal circuit of the LCD panel 200, and the electro-static discharge protection is achieved. The present embodiment of the invention is exemplified using the example of the diode array 702a and the diodes D1˜D4 thereof. However, the structure of the diode array 702b and the electro-static discharge protection achieved thereby can be obtained in the same way as the diode array 702a does.

### Sixth Embodiment

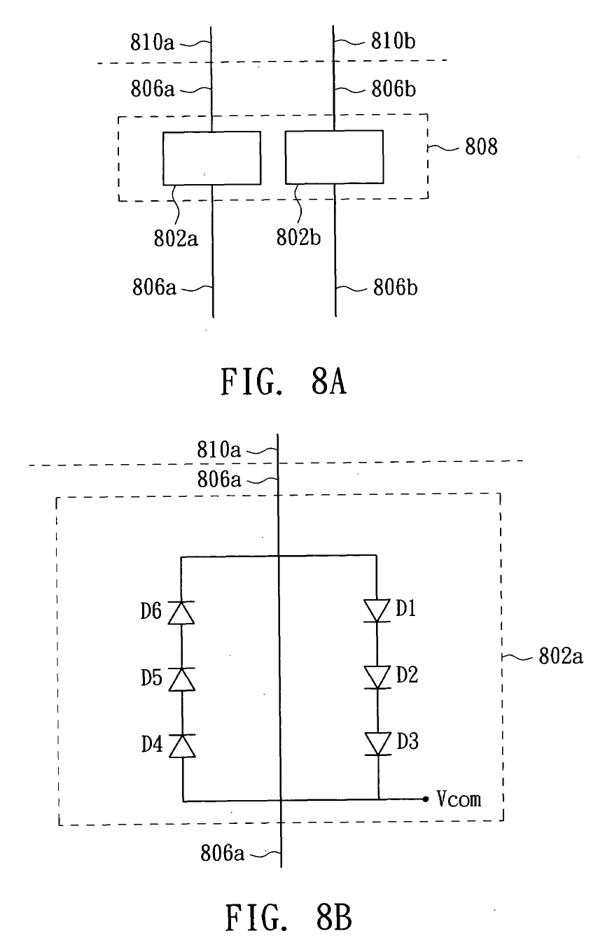

Referring to FIGS. 8A and 8B. FIG. 8A is a circuit diagram of an ESD protection device according to a sixth embodiment of the invention. FIG. 8B is a detailed circuit diagram of a diode array of FIG. 8A. The present embodiment of the invention differs with the fourth embodiment in that the diode arrays 802a and 802b of the present embodiment of the invention have different structures of electrical connection for the diodes. The present embodiment of the invention is further exemplified below using the example of the diodes D1˜D6 of the diode array 802a.

When the electro-static charges are discharged and generate a positive electro-static current, the positive electro-static current sequentially flows through the wires 810a, 806a, and the diodes D1˜D3 to be outputted to a common electrode Vcom. When the external electro-static charges are discharged and generate a reverse electro-static current, the positive electro-static current starts from the common electrode and sequentially flows through the diodes D4˜D6 and the wires 806a and 810a to be outputted. When the electro-static charges are discharged, the diode array 802a of the present embodiment of the invention effectively discharges the positive electro-static current and the reverse current via other path, such that the electro-static current is prevented from entering the internal circuit of the LCD panel 200, and the electro-static discharge protection is achieved. The present embodiment of the invention is exemplified using the example of the diode array 802a and the diodes D1˜D6 thereof. However, the structure of the diode array 802b and the electro-static discharge protection achieved thereby can be obtained in the same way as the diode array 802a does.

The above embodiments are exemplified by the second substrate 104 having two panel regions 104b. However, the TFT substrate 204 of the above embodiments can comprise one, three or more than three panel regions 104b. The first to the sixth embodiments are respectively exemplified by various circuit structures of ESD protection devices. However, the structure of the ESD protection device 108 of the invention is not limited to the structure of the ESD protection device disclosed above, and other structures also would do.

In above embodiments, the wires 106a, 106b, 110a and 110b electrically connected to the common electrode 102a and the electrode lines 104c respectively are disposed in the second substrate 104. However, the TFT substrate 204 of the above embodiments can further comprise a wire electrically connected to the scan lines 204d and the data line 204e, such that the voltage is applied via the wire electrically connected to the scan lines 204d, the data lines 204e and the electrode lines 104c to perform the PSA manufacturing process. The LCD sheet 100 of the above embodiments can further provide a cross-voltage to the two ends of the LC layer 103 via the PSA wire electrically connected to the electrode lines 104c, the scan lines 204d and the data lines 204e. The LCD sheet 100 of the above embodiments and the LCD panel 200 thereof achieve ESD protection by disposing the wires on an ESD protection device. Thus, any designs for protecting the internal circuit of LCD panel 200 from the interference of external electro-static charges by disposing an ESD protection device on the wire extended from the non-panel region 104a to the panel region 104b are within the scope of the technology of the invention.

According to the LCD sheet disclosed in the above embodiments of the invention, a wire is disposed on the second substrate, such that the PSA manufacturing process is applicable to multiple LCD panels of the LCD sheet. Thus, the LCD sheet of the invention effectively resolves the problem of incurring high manufacturing cost to the conventional PSA process which is applicable to only one LCD panel at a time.

According to the LCD sheet disclosed in the above embodiments of the invention, an electro-static discharge (ESD) protection device is further disposed on the wire of the second substrate, such that when the LCD sheet is divided into multiple LCD panels, and external electro-static charges are effectively prevented from entering the LCD panels via the wire extended to the LCD panels edge lest the internal circuit of the LCD panels might be damaged. Thus, the LCD sheet disclosed in above embodiments of the invention has the advantages of effectively preventing the LCD panels from being damaged by external electro-static charges during the manufacturing process, largely increasing the yield rate in the production of LCD panels, and further reducing LCD panel manufacturing cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD) sheet, comprising:
a first substrate;
a second substrate, having at least one panel region and a non-panel region, disposed opposite to the first substrate;
a first wire and a second wire both disposed on the second substrate and in the panel region;
a first electrostatic discharge (ESD) protection device disposed on the second substrate and electrically connected to the first and the second wires;
a third wire and a fourth wire both disposed on the second substrate and in the non-panel region and electrically connected to the first wire and the second wire, respectively; and
a liquid crystal (LC) layer disposed between the first and the second substrates.

2. The LCD sheet according to claim 1, further comprising a common electrode disposed on the first substrate and electrically connected to the first wire.

3. The LCD sheet according to claim 1, further comprising a plurality of electrode lines disposed on the second substrate and electrically connected to the second wire.

4. The LCD sheet according to claim 1, further comprising a plurality of polymers disposed on the first and the second substrates and positioned in the LC layer.

5. The LCD sheet according to claim 1, further comprising:
a plurality of scan lines and a plurality of data lines both disposed on the second substrate;
a plurality of second ESD protection devices disposed on the second substrate and electrically connected to the scan lines; and
a plurality of third ESD protection devices disposed on the second substrate and electrically connected to the data lines.

6. A liquid crystal display (LCD) panel comprising:
a first substrate;
a second substrate, having a wire region and a display region, parallel to the first substrate;
a first wire and a second wire both disposed on the second substrate and in the wire region, wherein one end of the first wire and one end of the second wire are substantially extended to a boundary of the second substrate;
an ESD protection device disposed on the second substrate and in the wire region and electrically connected to the first and the second wires; and
an LC layer disposed between the first and the second substrates.

7. The LCD panel according to claim 6, further comprising a common electrode disposed on the first substrate and electrically connected to the first wire.

8. The LCD panel according to claim 6, further comprising a plurality of electrode lines disposed on the second substrate and in the display region and electrically connected to the second wire.

9. The LCD panel according to claim 6, further comprising a plurality of polymers disposed on the first and the second substrates and positioned in the LC layer.

10. The LCD panel according to claim 6, further comprising:
a plurality of scan lines and a plurality of data lines disposed on the second substrate;
a plurality of second ESD protection devices disposed on the second substrate and electrically connected to the scan lines; and
a plurality of third ESD protection devices disposed on the second substrate and electrically connected to the data lines.

11. The LCD panel according to claim 6, wherein the ESD protection device comprises a plurality of capacitances.

12. The LCD panel according to claim 6, wherein the ESD protection device comprises a plurality of lightening protectors.

13. The LCD panel according to claim 6, wherein the ESD protection device comprises a plurality of diodes.
